(19) United States
(12) Patent Application Publication
(10) Pub. No.: US 2023/0343205 A1
(43) Pub. Date: Oct. 26, 2023

(54) A SENSOR SYSTEM FOR A BUILDING

(71) Applicant: METALLINE SMART BUILD LIMITED, Cannock (GB)

(72) Inventors: Darron BROUGH, Walsall (GB); Mohammed ZULFIQUAR, Birmingham (GB)

(21) Appl. No.: 17/917,818

(22) PCT Filed: Apr. 9, 2021
(86) PCT No.: PCT/GB2021/050870

§ 371 Date: Oct. 7, 2022

(30) Foreign Application Priority Data
Apr. 9, 2020 (GB) 2005281.7

(51) Int. Cl. G08B 29/04; A62C 37/40; G01D 11/30; A62B 1/02; E05F 15/72; E04H 9/14; G08B 17/00

(52) U.S. Cl. CPC G08B 29/043; A62C 37/40; G01D 11/305; A62B 1/02; E05F 15/72; E04H 9/14; G08B 17/00; E05Y 2900/148

(57) ABSTRACT

A sensor system for a building, the sensor system comprising a plurality of sensor units and a processing unit wherein the sensor units each comprise a plurality of electronic components which are provided either directly or indirectly via a substrate, on a surface of an external component of the building, or embedded within an external component of the building; and wherein each sensor unit comprises a sensor operable to monitor a building parameter, and a communication module operable to output a signal comprising data indicative of the monitored building parameter to the processing unit.

### TECHNICAL FIELD OF THE INVENTION

The present invention relates to a sensor system for a building, and in particular to a sensor system for improving the safety of the building. The invention extends to a sensor forming part of the sensor system, a building management system, an external fire suppression system and an external evacuation system.

### BACKGROUND TO THE INVENTION

Fire safety is of paramount importance for buildings, and in particular for buildings comprising multiple, perhaps in excess of 10, floors (which may be termed “high-rise” buildings). Typical fire safety measures include both fire detection systems and typically also fire suppression systems. For modern buildings, such measures may be integrated within the building, whereas older buildings may be retrofitted with such systems. Fire detection systems typically comprise one or more internal sensors configured to sense temperature rises or the presence of smoke which might be indicative of a fire. Fire suppression systems typically include sprinklers or fire extinguishing units positioned at one or more locations throughout the building operable to take preventative action upon detection of a possible fire—i.e. to attempt to control the fire and therefore reduce any impact.

At the same time, it has become increasingly common for buildings, and in particular high-rise buildings, to be cladded with a cladding material. Here, cladding refers to the application of one material over another, typically the application of a number of cladding panels over at least part of the exterior walls of a building. Cladding is used for thermal insulation and weather resistance purposes, and is also used to improve the exterior appearance of buildings. Cladding may typically be made up of a wide range of materials including wood, metal, brick, vinyl, and composite materials that can include aluminium, wheat/rice straw fibres, wood, blends of cement and recycled polystyrene, for example. It has been found that in some instances the use of such cladding materials has in fact increased the fire risk, and in some cases the severity of the impact of a fire, given the use of potentially combustible materials as part of the cladding panels.

Whilst improvements in cladding configuration and materials may serve to reduce or mitigate this risk, there is also a need for a system which can monitor building conditions and possibly initiate appropriate preventative actions. This is, in fact, true of both cladded and uncladded buildings, particularly where the building is a high-rise building with multiple floors. However, known internal systems may not be appropriate for buildings which are at least partially cladded, and where a fire may spread externally through said cladding.

Outside of fire safety there are further parameters and conditions which it might be advantageous to be able to monitor, including from a building occupant safety/health perspective (e.g. pollution levels) or an occupant comfort perspective (e.g. ambient temperature, weather conditions, etc.). Known internal fire safety systems are not suited to performing such a function.

It would therefore be advantageous to provide an external sensor system which can monitor one or more building conditions, particularly for cladded buildings. It would also be advantageous to provide a sensor or sensor system which may be retrofitted to existing buildings. It would also be advantageous to provide a building management system which can utilise data from the sensor system to take appropriate action where necessary.

It is therefore an aim of embodiments of the invention to overcome or mitigate at least one problem of the prior art.

### SUMMARY OF THE INVENTION

According to an aspect of the invention there is provided a sensor system for a building, the sensor system comprising a plurality of sensor units and a processing unit; wherein the sensor units each comprise a plurality of electronic components which are provided either directly or indirectly via a substrate, on a surface of an external component of the building, or embedded within an external component of the building; and wherein each sensor unit comprises: a sensor operable to monitor a building parameter; and a communication module operable to output a signal comprising data indicative of the monitored building parameter to the processing unit.

Advantageously the present invention provides an external sensor system which is operable to monitor at least one building parameter and output information indicative of that parameter to a processing unit. The processing unit may then take appropriate action depending on the monitored parameter. For example, where the monitored parameter may be indicative of a fire, which might include temperature or smoke levels, the processing unit may act on this information—e.g. by initiating a fire suppression system or sounding an alarm. Where the monitored parameter may be indicative of the external environment of the building, which may relate to pollution levels in the environment, the processing unit may act on this information—e.g. by operating a ventilation unit and/or closing one or more windows.

The external component of the building can include a cladding panel provided on or over an exterior surface of the building. For example, one or more of the sensor units may be embedded within a cladding panel. One or more of the sensor units may be provided on a surface of a cladding panel. One or more of the sensor units may be provided on an internal or external surface of the cladding panel.

The external component of the building can include a wall of the building. For example, one or more of the sensor units may be embedded within a brick, panel or the like forming a wall of the building. One or more of the sensor units may be provided on a surface of a wall of the building. One or more of the sensor units may be provided embedded within or on a surface of a window frame forming part of an external surface of the building.

One or more of the sensor units may comprise a substrate on which one or more electronic components are provided. The substrate may comprise strip, film or sheet in which the or each sensor and communication module is embedded or connected. The strip, film or sheet may comprise a conductive polymer in which the or each sensor and communication module is embedded or connected. The strip, film or sheet may comprise printed electronics components, such as for example printed circuit boards, which may be formed of conductive ink. Strips or sheets comprising conductive polymer or printed electronics are particularly useful as they enable thin strips, films or sheets to be applied to or be embedded within the external component of the building, thereby minimising any protrusion from the external component of the building, resulting in a sensor unit which is more difficult to remove accidentally or deliberately. The strip, film or sheet may comprise a cover or integral casing which may comprise a polymeric or metal film. The cover or casing may be configured to mitigate abrasion or damage to the strip, film or sheet, whilst still enabling operation of the or each sensor and the communication module.

In some embodiments, one or more sensor units may comprise one or more thin films of electrically-conductive material and/or one or more thin films comprising thin-film electronics configured to carry data and/or power between/to any sensors or other electrical components of the sensor unit(s). One or more of the sensor units may comprise one or more strips, films, sheets or panels formed from and/or comprising a thin-film electrically-conductive material. In some embodiments, one or more of the sensor units may comprise one or more thin-film electrically conductive channels, which may form discrete paths between the sensor and the communication module, and/or between further electrical components of the sensor unit. The one or more conductive channels may take the form of a web or grid of such channels, or may be in any suitable formation so as to facilitate effective communication between the sensor and further electrical components of the sensor unit. One or more sensor units may preferably comprise one or more thin films comprising printed electronics. The printed electronics may comprise the electrically-conductive material described above. In such embodiments, the thin film(s) may comprise a polymeric material such as a polyester material, for example polyethylene terephthalate.

One or more sensor units may comprise printed electronics which may, in some embodiments, be printed directly onto the external component of the building. This may be particularly suited to applications wherein the sensor system is incorporated during the construction of the building, or during fabrication of the cladding for an existing building, for example, where it may be possible to fully integrate the sensor system with the building rather than retrofit the system.

Any printed electronics of the sensor unit(s) may comprise an electrically-conductive ink and/or a dielectric ink. In some embodiments, the printed electronics may comprise a silver conductive ink.

The thin-film electronics may have a thickness of no more than 50 μm, 60 μm, 70 μm, 80 μm, 90 μm, 100 μm, 110 μm, 120 μm, 130 μm, 140 μm, 150 μm, 160 μm, 170 μm, 180 μm, 190 μm, or 200 μm. In some embodiments, the thin-film electronics may have a thickness of between 50 μm and 200 μm, such as between 60 μm and 190 μm or between 70 μm and 180 μm.

As described here, the sensor unit may be provided as a strip, film or sheet. In such embodiments the strip, film or sheet may comprise an adhesive region for adhesively securing the sensor unit to a surface of the external component of the building. Advantageously, each sensor unit may be provided as a “patch” which may be positioned at any desired position about the exterior of the building. In alternative embodiments the sensor unit may be provided within a casing. The casing may include an adhesive region or other coupling means for securing, coupling or otherwise connecting the sensor unit to the desired location on the external component of the building. For example, the casing may include one or more apertures for receiving coupling means in the form of screws or the like to secure the casing to the building component. Both the adhesive “patch”-type sensor unit, and the cased sensor unit may be particularly suited to applications which involve retrofitting of the sensor system to an existing building.

One or more of the sensor units may comprise a Micro Electro Mechanical System (MEMS) sensor. One or more of the sensor units may comprise a nanosensor.

One or more of the sensor units may comprise a temperature sensor. In such embodiments, the temperature sensor may be configured to output a measurement signal indicative of a monitored temperature. The measurement signal may be output via the corresponding communication module to the processing unit. The processing unit may be configured to interpret the measurement signal—e.g. determine the existence or absence of a fire or other environmental condition in dependence on the measurement signal, here in dependence on the measured temperature. The temperature sensor may incorporate one or more components which have a resistance which varies with temperature and/or pressure. Accordingly, measurement of the change in resistance may be used to monitor variations in temperature.

One or more of the sensor units may comprise a humidity sensor. In such embodiments, the humidity sensor may be configured to output a measurement signal indicative of a humidity level of the environment. Again, the measurement signal may be output via the corresponding communication module to the processing unit. The processing unit may be configured to interpret the measurement signal—e.g. determine the existence or absence of a fire or other environmental condition in dependence on the measurement signal, here in dependence on the measured humidity. The humidity sensor may comprise a differential capacitance type sensor having an electrode arrangement comprising a pair of electrode plates configured to measure variation in capacitance between the plates as it changes with humidity.

One or more of the sensor units may comprise an air quality sensor. In such embodiments, the air quality sensor may be configured to output a measurement signal indicative of a relative measure of a pollutant in the environment. The pollutant may comprise a particular type of gas (e.g. elevated levels of CO2 associated with a fire), compound and/or particulate in the monitored environment. The pollutant may comprise a group of particular gases, compounds and/or particulates in the monitored environment. In embodiments the air quality sensor may be configured to output a measurement signal indicative of a measure of a general air quality level affected by numerous different types of pollutants. Again, the measurement signal may be output via the corresponding communication module to the processing unit. The processing unit may be configured to interpret the measurement signal—e.g. determine the existence or absence of a fire or other environmental condition in dependence on the measurement signal, here in dependence on the measured level of a pollutant in the monitored environment. The air quality sensor may comprise a metal oxide semiconductor (MOS) sensor configured to detect concentration of various types of gases by measuring the resistance change of the metal oxide due to adsorption of those gases.

One or more of the sensors units may comprise a movement sensor, e.g. a stress or strain sensor. The movement sensor may be configured to output a measurement signal indicative of a movement of, for example, the external component to which (or within which) the sensor unit is positioned. In use, the particular external component, particularly where the external component comprises a cladding panel, may bend or warp under certain conditions (e.g. elevated temperatures associated with a fire).

One or more of the sensor units may comprise a smoke sensor. In such embodiments, the smoke sensor may be configured to output a measurement signal indicative of a smoke level of the environment. Again, the measurement signal may be output via the corresponding communication module to the processing unit. The processing unit may be configured to interpret the measurement signal—e.g. determine the existence or absence of a fire or other environmental condition in dependence on the measurement signal, here in dependence on the measured smoke. Any type of smoke sensor may be used.

In embodiments, one or more of the sensor units may comprise a single sensor operable to monitor a single building parameter. Each of the sensor units may comprise a single sensor operable to monitor a single building parameter. In alternative embodiments, one or more of the sensor units may comprise two or more sensors. The two or more sensors may be operable to monitor different building parameters.

The location of the respective types of sensors relative to the external component of the building may be particularly important. For example, it is important that the smoke sensor be located to detect smoke externally of the external component of the building, on an external side of the external component of the building and/or on an internal side of the external component of the building. It may be more important to detect heat or thermal changes within the cladding and/or on the interior side of the external component of the building. More than one type of sensor may be provided in a sensor unit. Typically, at least one heat sensor and at least one smoke sensor will be provided as a part of each sensor unit.

More than one sensor of the same type may be provided in a sensor unit. For example, a smoke sensor may be provided to detect smoke externally of the external component of the building and a second smoke sensor may be provided to detect smoke within or on an interior side of the external component of the building.

Still further, more than one sensor unit may be provided on a single external component of the building as this may allow the system to determine directionality relative to a fire based on which of the sensor units is triggered first.

Each of the sensor units may be operable to monitor the same building parameter. One or more of the sensor units may be operable to monitor a first building parameter, and one or more sensor units may be operable to monitor a second building parameter, different to the first.

One or more of the sensor units may be powered via a wired connection to a power supply, e.g. a mains power supply. In further embodiments, one or more of the sensor units may be powered via an internal power supply, e.g. an internal battery. One or more of the sensor units may comprise a solar cell operatively coupled to the sensor unit, optionally forming part of the sensor unit, and configured to power operation of the sensor unit, e.g. by charging an internal power supply. Advantageously, having the sensor unit(s) powered separate from a mains power supply may enable the sensor system to operate where there is a power failure for the building, which may be increasingly more likely in the event of a fire.

The communication module for each sensor may comprise a wired communication module which is hardwired with the processing unit. Alternatively, the communication module may comprise a wireless communication module, such as a Wi-Fi module, radio module, 3G module or 4G module, for example, operable to communicate with the processing unit over a wireless communication network.

The communication module for each sensor may be operable to communicate with the processing unit and/or the communication module of one or more further sensor units to determine a relative location of the corresponding sensor unit. For example, the communication module for each sensor system and/or the processing unit may be operable to determine a signal strength (e.g. received signal strength—RSS) for signal(s) received from one or more further sensor units and/or the processing unit. The signal strength may be used to determine a relative location of each of the sensor units, e.g. via triangulation. In other embodiments, the location may be programmed (e.g. upon installation) for each sensor unit, and each sensor unit may be operable to communicate its programmed location to the processing unit and/or one or more further sensor units Advantageously, each sensor unit may be operable to determine its relative location about the building. This may be particularly advantageous where the sensor system is retrofitted to an existing building, and the precise location of each sensor unit may not be known.

The processing unit of the sensor system is configured to receive signals from the plurality of sensor units indicative of one or more building parameters. The processing unit may be configured to analyse those signals to determine a building condition. For example, where the building condition relates to the presence or absence of a fire, the processing unit may be operable to receive signals from a plurality of sensor units monitoring building parameters including temperature and/or air quality and be operable to determine in dependence on the received signals whether there is a fire, or not. Where the building condition relates to the building's environment, e.g. a pollutant level in the environment, the processing unit may be operable to receive signals from a plurality of sensor units monitoring an air quality and be operable to determine in dependence on the received signals a level of air quality associated with the building's environment.

The processing unit may be configured to communicate with, or form part of, a building management system for the building. The building management system may include multiple different subsystems operable to control different functions of the building, including sounding of fire/smoke/evacuation alarms, deployment of fire suppression systems such as sprinklers or extinguishers, control of ventilation systems including air conditioning and heating systems, opening and closing of windows and doors, amongst other functions.

The processing unit may be configured to generate and output a control signal for causing operation of a particular subsystem of the building management system in dependence on the monitored building parameter or determined building condition. The control signal may be output to a central building management controller, or may be output directly to the particular subsystem.

The processing unit may be operable to cause operation of an internal or external alarm. For example, the processing unit may be operable to output a control signal for sounding an alarm within the building, which may be throughout the building or at a given location within the building dependent on the location of the sensor units triggering operation of said alarm. The processing unit may be operable to output a control signal to alert a third party (e.g. an emergency service provider) of the building condition—e.g. alert a fire service in the event of a fire detected by one or more sensor units of the sensor system. The processing unit may comprise a communication module for communicating with the third party, or may cause operation of a communication module of the building management system.

The processing unit may be operable to cause operation of an internal fire suppression system. For example, the processing unit may be operable to output a control signal for activating a fire suppression system within the building, which may be throughout the building or at a given location within the building dependent on the location of the sensor units triggering operation of said suppression system. The internal fire suppression system may comprise a sprinkler system and/or an extinguisher system.

In embodiments, the building management system may include an external fire suppression subsystem. The external fire suppression subsystem may comprise an external suppression unit located on the exterior of the building and configured to release a fire suppression agent onto an exterior surface of the building. The external suppression unit may be positioned at or proximal to the roof of the building and be configured to release the fire suppression agent under gravity onto the exterior of one or more sides of the building. The fire suppression unit may be fixed, or may be moveable. There may be a plurality of fixed fire suppression units, e.g. at various heights/floors of the building. In a variant, the external fire suppression subsystem may comprise a plurality of moveable fire suppression units. The moveable fire suppression units may be provided on one or more tracks (e.g. vertical and or horizontal tracks) on the exterior of the building. The moveable fire suppression units may be moveable along said track(s) to a desired location on the exterior of the building—e.g. a location a possible fire as determined by the processing unit of the sensor system based on signals received from one or more sensor units—and be operable to release a fire suppression agent onto and/or into the building. The fire suppression agent may comprise water, or a fire extinguishing agent, such as a chemical or powder agent. The processing unit may be operable to cause operation of the external fire suppression subsystem. For example, the processing unit may be operable to output a control signal for activating the external fire suppression subsystem by causing movement of one or more fire suppression units to a position dependent on the location of the sensor units triggering operation of said suppression subsystem and/or control release of said fire suppression agent from the fire suppression unit(s).

In embodiments the building management system may include an external evacuation subsystem. The external evacuation subsystem may comprise at least one external elevator, the or each elevator being moveable with respect to the exterior surface of the building. There may be a plurality of external elevators. The external elevator may be moveable and may be provided on one or more tracks (e.g. vertical and or horizontal tracks) on the exterior of the building. The external elevators may be moveable along said track(s) to a desired location on the exterior of the building—e.g. a location at or proximal to a possible fire as determined by the processing unit of the sensor system based on signals received from one or more sensor units. The external elevators may be operable to move between exit points on the building, e.g. windows, fire escapes and the like, to enable evacuation of occupants of the building in the event of a fire or the like. For example, it may be desirable or necessary to evacuate occupants on floors above the location of a fire in the building via the external elevator(s), whose normal exit route may otherwise be blocked due to the fire. The external elevators may be situated at the top of the building (e.g. on or within the roof of the building) and may be deployed under the control of the processing unit of the sensor system—either directly or indirectly via a central controller of the building management system. There may be a plurality of external elevators provided at different floors of the building, for example every ten floors. The processing unit may be operable to cause operation of the external evacuation subsystem. For example, the processing unit may be operable to output a control signal for activating the external evacuation subsystem by causing movement of one or more external elevators to a position dependent on the location of the sensor units triggering operation of said evacuation subsystem.

In embodiments the building management system may comprise a heating, ventilation and/or air conditioning (HVAC) subsystem. The HVAC subsystem may be operable to control the temperature and/or ventilation within the building, and may be controlled in dependence on the building parameters monitored by the sensor units of the sensor system. For example, a heating or air conditioning/cooling system may operate in dependence on the external temperature—e.g. as sensed by sensor units comprising a temperature sensor. A ventilation system may operate in dependence on an air quality, or humidity of the environment. The processing unit may be operable to cause operation of the HVAC subsystem. For example, the processing unit may be operable to output a control signal for activating the HVAC subsystem to raise or lower the temperature, or to increase or decrease ventilation within the building, which may optionally also be dependent on the location of the sensor units triggering operation of HVAC subsystem.

In embodiments the building management system may comprise a window control subsystem. The window control subsystem may be operable to control opening and closing of one or more windows within the building, and may be controlled in dependence on the building parameters monitored by the sensor units of the sensor system. For example, the window control subsystem may operate in dependence on the external air quality—e.g. as sensed by sensor units comprising an air quality sensor. For example, for high detected levels of a pollutant or poor overall air quality in the building's environment, the window control subsystem may be used to automatically close windows to control air quality within the building. The processing unit may be operable to cause operation of the window control subsystem. For example, the processing unit may be operable to output a control signal for activating the window control subsystem to open or close one or more windows of the building, which may optionally also be dependent on the location of the sensor units triggering operation of window control subsystem—e.g. on a certain side of the building.

According to another aspect of the invention there is provided a sensor unit for use in a sensor system according to the preceding aspect of the invention, the sensor unit comprising: a sensor operable to monitor a building parameter; and a communication module operable to output a signal comprising data indicative of the monitored building parameter to a processing unit of the sensor system.

The sensor unit may be as described above, and may comprise any one or more of the features of the sensor unit(s) of the preceding aspect of the invention as desired or appropriate.

According to an aspect of the invention there is provided an external component for a building, the external component comprising the sensor unit of the preceding aspect provided either directly or indirectly via a substrate, on a surface thereof, or embedded therein.

The external component may preferably comprise a cladding panel.

According to another aspect of the invention there is provided a building management system for a building, the building management system comprising the sensor system of any preceding aspect of the invention and a plurality of subsystems controllable in dependence on operation of the sensor system.

The building management system may be as described herein with reference to the preceding aspects, and may comprise any one or more features of any building management system described herein as desired or appropriate.

According to a further aspect of the invention there is provided an external fire suppression system for a building, the external fire suppression system comprising: one or more external suppression units located on an exterior of the building configured to release a fire suppression agent onto an exterior surface of the building.

The external fire suppression system may comprise an external suppression unit positioned at or proximal to the roof of the building. The suppression unit may be configured to release the fire suppression agent under gravity onto the exterior of one or more sides of the building.

The fire suppression unit may be fixed, or may be moveable. There may be a plurality of fixed fire suppression units, e.g. at various heights/floors of the building.

In a variant, the external fire suppression system may comprise a plurality of moveable fire suppression units. The moveable fire suppression units may be provided on one or more tracks (e.g. vertical and or horizontal tracks) on the exterior of the building. The moveable fire suppression units may be moveable along said track(s) to a desired location on the exterior of the building—e.g. a location a possible fire. The moveable fire suppression units may be moveable automatically along said track(s).

The location of a possible fire may be determined through monitoring of one or more building parameters (e.g. temperature) by one or more sensors distributed across an exterior of the building. For example, the external fire suppression system may be operable under control of a sensor system according to any preceding aspect, with the location of a possible fire determined via sensor units distributed about the exterior of the building.

The fire suppression agent may comprise water, or a fire extinguishing agent, such as a chemical or powder agent. The or each fire suppression unit may comprise a sprinkler head and hose connected to a water supply.

According to an aspect of the invention there is provided an external evacuation system for a building, the external evacuation system comprising: one or more external elevators, the or each external elevator being moveable with respect to an exterior surface of the building.

The or each external elevator may be provided on one or more tracks (e.g. vertical and or horizontal tracks) on the exterior of the building. The or each external elevator may be moveable along said track(s) to a desired location on the exterior of the building—e.g. a location at or proximal to a possible fire, which may be determined by using the sensor system of any preceding aspect—i.e. based on signals received from one or more sensor units of the sensor system.

The external elevators may be operable to move between exit points on the building, e.g. windows, fire escapes and the like, to enable evacuation of occupants of the building in the event of a fire or the like. For example, it may be desirable or necessary to evacuate occupants on floors above the location of a fire in the building via the external elevator(s), whose normal exit route may otherwise be blocked due to the fire.

The external elevators may normally be situated at the top of the building (e.g. on or within the roof of the building) and may be deployed under the control of a processing unit in the event of a need to evacuate occupants from the building. There may be a plurality of external elevators normally provided at different floors of the building, for example every ten floors.

In an embodiment, the system is an integrated system which is activated through a sequence of sensors (provide on one or more external components of the building to form an external envelope). The sensors in the system will typically operate crosschecking the information from one sensors against information from one or more other sensors nearby. Typically, multiple secondary checks of the information from one or more sensors are undertaken through software algorithms. Based on the cross-checked information, the system may activate a rain curtain water sprinkler system such as that disclosed herein.

Both software and hardware sensors are typically pre-programmed to add a rain curtain water sprinkler system as an option as and when a client chooses.

The sensor unit may be provided in one of two formats namely a retrofit format or a newbuild format.

The retrofit format preferably utilises sensors installed to an existing building configuration without removing existing external components of the building or cladding panels. The one or more sensors can be positioned anywhere, but may be adjacent to a window—balcony area in buildings with external access. The one or more sensors then typically communicate with the management system, either through wired or wireless connection.

In the newbuild format, the sensors are typically installed inside the existing external components of the building or cladding panels from manufacture so when the existing external components of the building or cladding panels arrive on site, they are ready to plug and play to whatever the configuration of the building system. The two main connectors necessary are power and data, and these can be wireless or wired.

### DETAILED DESCRIPTION OF THE INVENTION

In order that the invention may be more clearly understood one or more embodiments thereof will now be described, by way of example only, with reference to the accompanying drawings, of which:

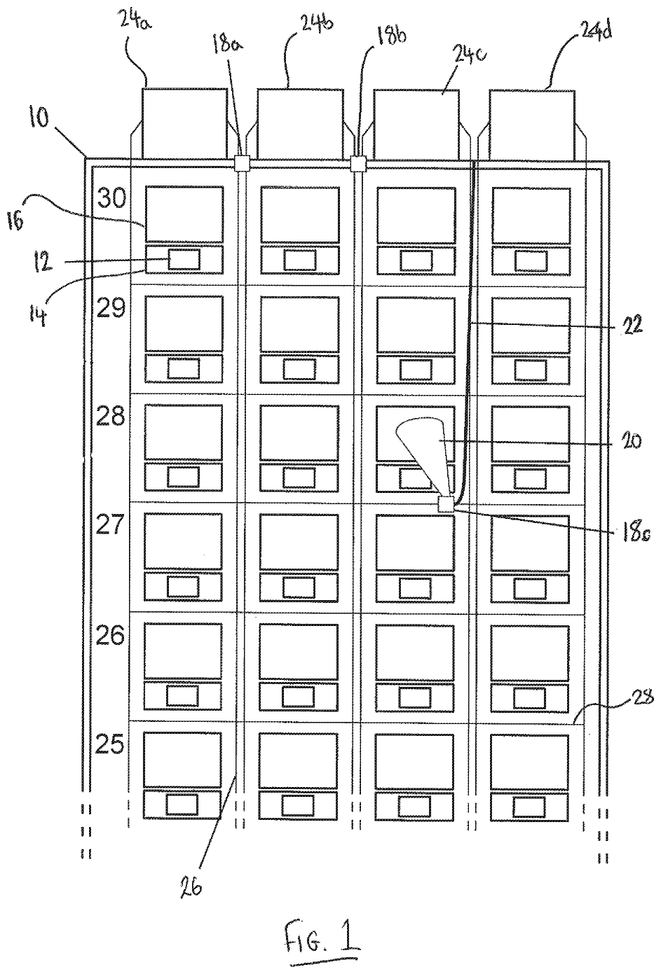

FIG. 1 is a schematic overview of building incorporating multiple aspects of the present invention;

FIG. 2 is a schematic overview of an embodiment of a sensor system of the invention;

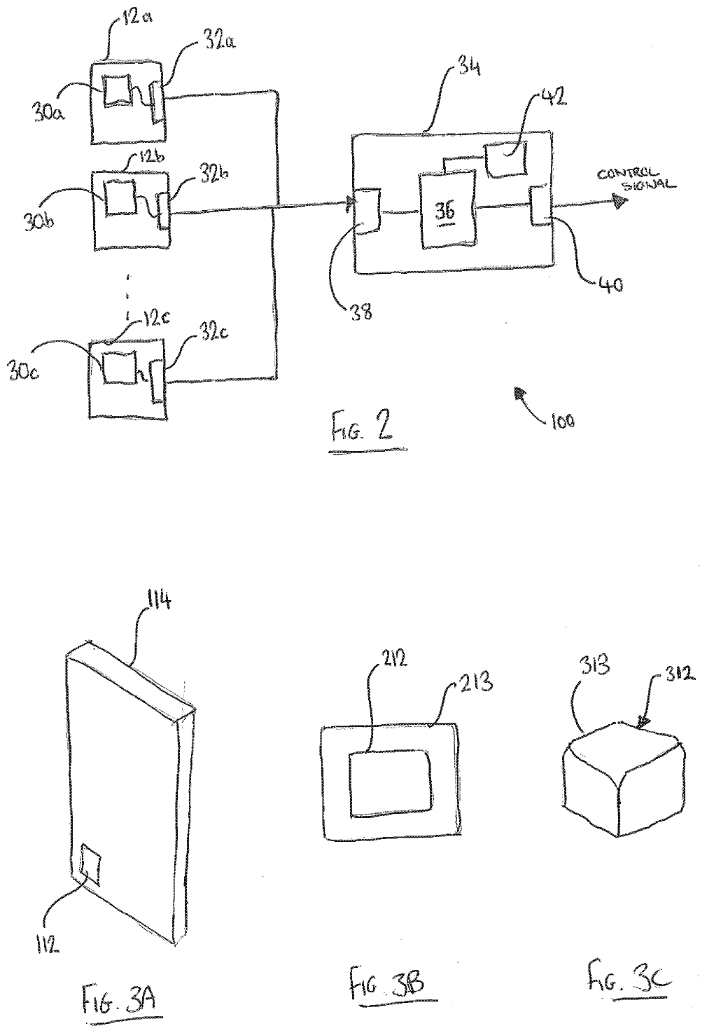

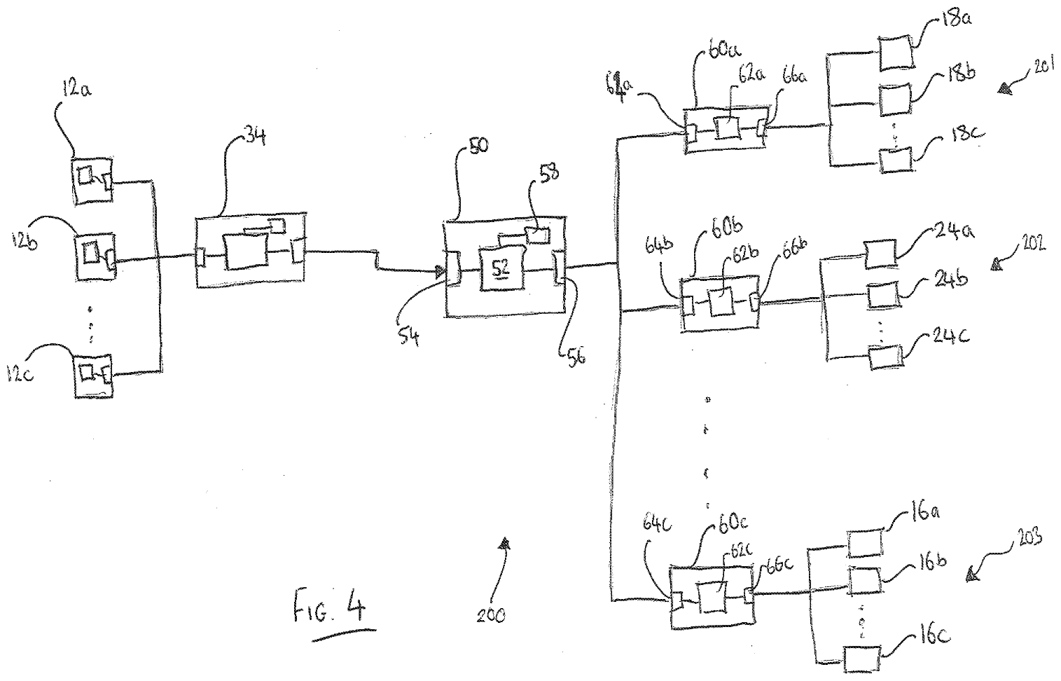

FIGS. 3A-3C are a series of diagrams illustrating embodiments of a sensor unit of the invention for use as part of the sensor system of FIG. 2; and

FIG. 4 is a schematic overview of an embodiment of a building management system of the invention.

In general, the present invention relates to a sensor system 100 and building management system 200 for a building 10, with the sensor system 100 being operable to monitor one or more building parameters via sensor units 12 distributed across the exterior of the building 10, and appropriate actions performed based on the sensed parameters, including operating various subsystems of the building management system 200 which may include a fire suppression subsystem 201, an external evacuation subsystem 202 and a window control subsystem 203.

FIG. 1 is a schematic diagram illustrating an exemplary building 10, where various embodiments of the present invention may function. As shown, the building 10 is a high-rise building having thirty floors.

The building 10 is provided with a plurality of sensor units 12 forming a sensor system 100. Each sensor unit 12 includes a sensor 30 for monitoring a building parameter and communication module 32 for communicating with a processing unit 34 of the sensor system 100, specifically by outputting signals indicative of the monitored parameter back to the processing unit 34 for further processing. The communication module 32 preferably comprises a wireless communication module 32 configured to communicate with the processing unit 34 over a wireless communication network, such as a WiFi network. The sensor units 12 also include an internal power source in the form of a rechargeable battery (not shown) powered via one or more solar cells (not shown).

In the illustrated embodiment, the sensors 30 of each sensor unit 12 comprise low cost microelectromechanical systems (MEMS) sensors 30. Advantageously, such sensors are relatively cheap to manufacture, are lightweight and are small in size, enabling large scale industrial manufacture, and implementation on the building 10 at a reasonable cost. Each sensor unit 12 is configured to monitor one or more building parameters, including temperature, air quality, gases (e.g. CO2 levels) and movement. The sensor units 12 can include one or multiple sensors, the invention is not limited in this sense.

Here, the sensor units 12 are embedded in a cladding panel 14 on the exterior surface of the building 10, specifically in a cladding panel 14 situated below a corresponding window 16 of the building 10. The sensor units 12 may take any one of a number of different forms. For instance, the sensor units 12 can include a sensor unit 112 which comprises electronic circuitry printed or otherwise fabricated directly onto a surface of the cladding panel 114 (FIG. 3A). Such embodiments may be particularly suited to a sensor system 100 which is incorporated into the building 10 during construction of the building and/or cladding panels 114. Additionally or alternatively, the sensor units 12 can include a sensor unit 212 comprising electronic circuitry printed or otherwise fabricated on a (optionally flexible) substrate 213 (FIG. 3B), with the substrate being configured to be coupled or otherwise fixed to, or embedded within, the external component of the building, e.g. to the cladding panel 14. The substrate can, for instance, comprise an adhesive region. Where the substrate comprises a flexible substrate, this may advantageously form a sensor unit 212 in the form of a flexible “patch” which may be quickly and easily stuck onto an external component of the building, e.g. the cladding panel 14. This may be particularly suited to “retrofit” applications, where the sensor system 100 can be quickly and easily set up on an existing building 10 by simply affixing the sensor units 212 thereto. Additionally or alternatively, the sensor units 12 can include an individual boxed sensor unit 312 (FIG. 3C) adapted to be attached to or embedded in the surface of a cladding panel 14. Again, this may be particularly suited to “retrofit” applications, where the sensor system 100 can be quickly and easily set up on an existing building 10 by simply affixing the sensor units 312 thereto.

The building 10 includes a fire suppression subsystem 201 forming part of the building management system 200 and which is controllable under the operation of the sensor system 100 as described herein. The fire suppression subsystem 201 includes a number of fire suppression units 18a, 18b, 18c each operable to release a suppression agent 20 (e.g. water) onto the exterior of the building 10. A supply line 22 is provided which supplies the units 18a, 18b, 18c with the suppression agent 20 from a reservoir, here located at the top of the building 10. Advantageously, the suppression units 18a, 18b, 18c are provided on a series of vertical and horizontal tracks 26, 28 and are moveable along those tracks in order to position the units 18a, 18b, 18c as desired—e.g. proximal to a location of a fire as detected by sensor units 12.

The building 10 also includes an external evacuation subsystem 202 forming part of the building management system 200 and which is controllable under the operation of the sensor system 100 as described herein. The external evacuation subsystem 202 includes a number of evacuation pods 24a, 24b, 24c, 24d normally located at or on the roof of the building 10. Advantageously, the evacuation pods 24a, 24b, 24c, 24d are each operable to move along the tracks 26, 28 to move to a position at or proximal to a window 16 or other exit point on the building 10, enabling occupants within the building to board the pods 24a, 24b, 24c, 24d and thereby evacuate the building. The movement of the pods 24a, 24b, 24c, 24d is preferably triggered by the sensor units 12 upon detection of a building condition requiring an evacuation—e.g. detection of a fire at a particular location within the building 10.

FIG. 2 schematically illustrates the sensor system 100 further.

The sensor system 100 includes a plurality of sensor units 12a, 12b, 12c and a processing unit 34 operably connected to one another. Here, the sensor units 12a, 12b, 12c and processing unit 34 are communicable wirelessly over a wireless communication network, providing greater flexibility over the positioning of the sensor units 12a, 12b, 12c across the building 10.

Each sensor unit 12a, 12b, 12c includes respective sensors 30a, 30b, 30c in the form of MEMS sensors 30a, 30b, 30c each configured to monitor a building parameter (e.g. temperature, humidity, air quality). Further, each sensor unit 12a, 12b, 12c includes respective communication modules 32a, 32b, 32c operable to communicate over a wireless communication network with the processing unit 34, specifically to send signals comprising data indicative of the monitored building parameter for further processing by the processing unit 34.

The processing unit 34 includes an electronic processor 36, electrical input 38 and electrical output 40. The processor 36 is configured to access a memory device 42 having instructions stored therein, and execute those instructions for performing aspects of the invention as will be described herein. The electrical input 38 is configured to receive signals from sensor units 12a, 12b, 12c for processing by the processing unit 34, and specifically by the processor 26. The electrical output 40 is configured to output control signals for causing operation of one or more subsystems of the associated building management system, e.g. the fire suppression subsystem 201, external evacuation subsystem 202 or a window control subsystem 203 in dependence on the monitored building parameter(s).

Here, each of the sensors 30a, 30b, 30c comprises a temperature sensor. The output signal from the sensor units 12a, 12b, 12c are therefore indicative of an ambient temperature associated with the location of those units 12a, 12b, 12c on the building. For example, a current-voltage characteristic of the output signal from sensor unit 12a, 12b, 12c may be dependent on the ambient temperature. The current-voltage characteristic can be interpreted (e.g. by the processing unit 36) to extract the sensed ambient temperature. Where the monitored ambient temperature exceeds a certain threshold this may be indicative of the presence of a fire at a particular location of the building 10, and appropriate actions may therefore be initiated.

In a variant, one or more sensors 30a, 30b, 30c can comprise an air quality sensor. The output signal from the associated sensor unit 12a, 12b, 12c in such instances may be indicative of relative level of a pollutant in at a particular location of the building 10. As will be appreciated, this may involve monitoring a level of a particular pollutant, group of pollutants or a general air quality measure affected by numerous different pollutants. A current-voltage characteristic of the output signal from the sensor unit(s) 12a, 12b, 12c may be dependent on the relative level of the pollutant measured. The current-voltage characteristic can be interpreted (e.g. by the processing unit 36) to extract the sensed pollutant level. The presence of a pollutant may simply relate to the air quality of the building's environment, or in some instances the monitored pollutant may directly correlate to the presence of a fire (e.g. increased CO2 levels). Using this information, appropriate actions may be taken—e.g. for poor air quality one or more windows of the building may be closed via window control subsystem 203, or in the event of a fire, the fire suppression subsystem 201 and/or external evacuation subsystem 202 may be triggered.

FIG. 4 schematically illustrates the sensor system 100 further, and its incorporation into the building management system 200.

The building management system 200 includes a building management controller 50 operably connected to the processing unit 34 of the sensor system 100. Again, the processing unit 34 and building management controller 50 may be communicable wirelessly over a wireless communication network, providing greater flexibility, but could equally be connected over a wired connection, as will be appreciated.

The building management controller 50 includes an electronic processor 52, electrical input 54 and electrical output 56. The processor 52 is configured to access a memory device 58 having instructions stored therein, and execute those instructions for performing aspects of the invention as will be described herein. The electrical input 54 is configured to receive control signals from the processing unit 34 of the sensor system 100 and operate in accordance with those control signals to take appropriate action based on the parameter(s) monitored by the sensors 30a, 30b, 30c of respective sensor units 12a, 12b, 12c. The electrical output 56 is configured to output control signals for controlling operation of subsystems of the building management system 100, which include the fire suppression subsystem 201, the external evacuation subsystem 202 and a window control subsystem 203.

Each subsystem 201, 202, 203 includes respective subsystem controllers 60a, 60b, 60c, each comprising respective electronic processors 62a, 62b, 62c, electrical inputs 64a, 64b, 64c and electrical outputs 66a, 66b, 66c. The inputs 64a, 64b, 64c are each configured to receive control signals from the building management controller 50, those control signals being processed by respective processors 62a, 62b, 62c to determine the action instructed by the building management controller 50. Each subsystem controller 60a, 60b, 60c uses respective electrical outputs 66a, 66b, 66c to output control signals for controlling operation of one or more components of the respective subsystem 201, 202, 203.

For instance, the subsystem controller 60a for the fire suppression subsystem 201 is operable to output control signals for controlling the position and/or operation (e.g. dispensing of suppression agent) from one or more of the fire suppression units 18a, 18b, 18c. As described herein, this may involve causing movement of one or more units 18a, 18b, 18c along the vertical and/or horizontal tracks 26, 28 on the exterior of the building 10 to move the unit(s) into position at or proximal to the location of a suspected fire as determined by sensor system 100, before causing release of the fire suppression agent onto the exterior of the building 10 in an attempt to control the fire.

The subsystem controller 60b for the fire suppression subsystem 202 is operable to output control signals for controlling the position and/or operation of one or more of the external evacuation pods 24a, 24b, 24c. As described herein, this may involve causing movement of one or more pods 24a, 24b, 24c 18c along the vertical and/or horizontal tracks 26, 28 on the exterior of the building 10 to move the pods into position at or proximal to the location of a suspected fire as determined by sensor system 100, or indeed any exit point on the building 10 where occupants may need to be evacuated from.

The subsystem controller 60c for the window control subsystem 203 is operable to output control signals for controlling the operation of one or more windows 16 on the building 10. As described herein, this may involve causing one or more windows 16 of the building 10 to close upon detection of a drop in air quality as determined by one or more sensor units 12a, 12b, 12c positioned at or proximal to those windows. In a variant, a further subsystem controller may be operable to control operation of a heating, air conditioning and/or ventilation system of the building 10, for example based on one or more parameters including air quality or ambient temperature for occupant safety or comfort. In a further variant, a subsystem controller may be operable to cause output of an alarm or alert based on the monitored parameters—e.g. to notify occupants of the building of a possible fire or other emergency situation, and/or to notify one or more external parties (e.g. an emergency service provider).

The one or more embodiments are described above by way of example only. Many variations are possible without departing from the scope of protection afforded by the appended claims.

1. A sensor system for a building, the sensor system comprising a plurality of sensor units and a processing unit:
wherein the sensor units each comprise a plurality of electronic components which are provided either directly or indirectly via a substrate, on a surface of an external component of the building, or embedded within an external component of the building; and
wherein each sensor unit comprises:
a sensor operable to monitor a building parameter; and
a communication module operable to output a signal comprising data indicative of the monitored building parameter to the processing unit.

2. A sensor system as claimed in claim 1, wherein the external component of the building comprises a cladding panel provided on or over an exterior surface of the building, and wherein one or more of the sensor units are be embedded within a cladding panel, or are provided on an internal or external surface of the cladding panel.

3. A sensor system of claim 1, wherein one or more of the sensor units are provided embedded within or on a surface of a window frame forming part of an external surface of the building.

4. A sensor system as claimed in claim 1, wherein one or more of the sensor units comprise a substrate on which one or more electronic components are provided, the substrate comprising a strip, film or sheet in which the or each sensor and communication module is embedded or connected.

5. (canceled)

6. A sensor system of claim 1, wherein one or more sensor units comprise printed electronics printed directly onto the external component of the building.

7. (canceled)

8. (canceled)

9. A sensor system of claim 1, wherein one or more of the sensor units comprise one or more of: a smoke sensor, a temperature sensor; a humidity sensor; an air quality sensor; and a movement sensor.

10. A sensor system of claim 1, wherein one or more of the sensor units are powered via an internal power supply, and comprise a solar cell operatively coupled to or forming part of the sensor unit, and configured to power operation of the sensor unit by charging an internal power supply.

11. (canceled)

12. A sensor system of claim 1, wherein the processing unit is configured to:
receive signals from the plurality of sensor units indicative of one or more building parameters; and
generate and output a control signal for causing operation of a subsystem of a building management system in dependence on the monitored building parameter.

13. A sensor system as claimed in claim 12, wherein the processing unit is operable to cause operation of an internal or external alarm.

14. A sensor system as claimed in claim 12, wherein the processing unit is operable to cause operation of an external tire suppression subsystem, wherein the external fire suppression subsystem comprises a plurality of moveable fire suppression units provided on one or more tracks on the exterior of the building, the units being moveable along said track(s) to a desired location on the exterior of the building as determined by the processing unit of the sensor system based on signals received from one or more sensor units.

15. A sensor system of claim 12, wherein the processing unit is operable to cause operation of an external evacuation subsystem, wherein the external evacuation subsystem comprises at least one external elevator moveable with respect to the exterior surface of the building along one or more tracks on the exterior of the building to a desired location on the exterior of the building as determined by the processing unit of the sensor system based on signals received from one or more sensor units.

16. A sensor system as claimed in claim 12, wherein the processing unit is operable to cause operation of a window control subsystem, the window control subsystem being operable to control opening and closing of one or more windows within the building in dependence on the building parameter(s) monitored by the one or more sensor units of the sensor system.

17. A sensor unit for use in a sensor system according to claim 1, the sensor unit comprising: a sensor operable to monitor a building parameter; and a communication module operable to output a signal comprising data indicative of the monitored building parameter to a processing unit of the sensor system.

18. (canceled)

19. An external fire suppression system for a building, the external fire suppression system comprising: one or more external suppression units located on an exterior of the building configured to release a fire suppression agent onto an exterior surface of the building.

20. An external fire suppression system of claim 19, comprising an external suppression unit positioned at or proximal to the roof of the building, the suppression unit being configured to release the fire suppression agent under gravity onto the exterior of one or more sides of the building.

21. An external fire suppression system of claim 19, comprising a plurality of moveable fire suppression units, the moveable fire suppression units being provided on one or more tracks on the exterior of the building and being moveable along said track(s) to a desired location on the exterior of the building.

22. An external evacuation system for a building, the external evacuation system comprising: one or more external evacuation elevators, each external elevator being moveable with respect to an exterior surface of the building.

23. An external evacuation system as claimed in claim 22, wherein each external elevator is provided on one or more tracks on the exterior of the building, and is moveable along said track(s) to a desired location on the exterior of the building.

24. An external evacuation system of claim 23, wherein each external elevator is operable to move between exit points on the building to enable evacuation of occupants of the building in the event of a fire or the like.

25. A sensor system as recited in claim 1, wherein the building includes a building management system having a plurality of subsystems controllable in dependence on operation of the sensor system.
